(19) United States
(12) Patent Application Publication
(10) Pub. No.: US 2023/0093033 A1
(43) Pub. Date: Mar. 23, 2023

(54) LOW SODIUM PROCESSED CHEESE AND METHOD OF PRODUCING IT

(71) Applicant: Arla Foods Amba, Viby J (DK)

(72) Inventors: Bo Hedegaard Johansen, Viby J (DK); Claus Bukbjerg Andersen, Viby J (DK); Franz Petterson, Viby J (DK); Karoline Borg Thomsen, Viby J (DK)

(21) Appl. No.: 17/795,248

(22) PCT Filed: Jan. 29, 2021
(86) PCT No.: PCT/EP2021/052131

§ 371 Date: Jul. 26, 2022

(30) Foreign Application Priority Data
Jan. 29, 2020 (EP) 20154414.5

(51) Int. Cl. A23C 19/082

(52) U.S. Cl. CPC A23C 19/082

(57) ABSTRACT

The present invention pertains to a low sodium processed cheese comprising significant amounts of micellar casein isolate and a method of producing it.

### BACKGROUND

Processed cheese is a special type of cheese, which is prepared by melting natural cheese in the presence of so-called melting salts (e.g. disodium-hydrogen-phosphate or tri-sodium citrate dihydrate) under moderate heating. Natural cheese typically contains 600-900 mg sodium/100 g cheese and the added melting salts further increase the total sodium content of a processed cheese. Traditional processed cheeses therefore have a relatively high level of sodium—often 1.7 g sodium per 100 g processed cheese or even more.

Previous attempts to prepare low sodium processed cheeses have involved the use of potassium-based melting salts instead of sodium-based melting salts or the use of low sodium natural cheeses as starting material for producing the processed cheese.

For example, US 2002/0187237 A1 discloses a method of making processed cheese, especially mozzarella type cheese, comprising the steps of A) preparing a blend comprising young low sodium-chloride cheese, hydrocolloids, and emulsifying salts, B) cooking the blend as obtained in step A to create a fibrous structure, and C) holding the fibrous structure as obtained in step B at an elevated temperature, wherein sodium chloride is added immediately before or during step C. US 2002/0187237 A1 also discloses the production of processed cheese obtainable by the above method, especially individually-wrapped cheese in slices.

Hammam (Ahmed Hammam; “Production and Storage Stability of High Concentrated Micellar Casein and its Effect on the Functional Properties of Process Cheese Products”, Electronic Theses and Dissertations. 3411, 2019, XP055717612; South Dakota State University) discloses production of processed cheese from aged process cheese supplemented with micellar casein and investigates the impact of addition of NaCl to the liquid micellar casein on different properties of the shelf-life of the processed cheese.

WO 2012/023863 A discloses a method for producing processed cheese with reduced sodium content, and describes that the method retains desirable organoleptic characteristics, processability, food safety attributes and functional characteristics normally associated with processed cheese having normal sodium content.

### SUMMARY OF THE INVENTION

The present inventors have found that tasty processed cheese products can be produced by replacing at least some of the natural cheese with micellar casein isolate (MCI), and interestingly they have found that less melting salts are required for producing a MCI-containing processed cheese than for producing a traditional processed cheese. The melting salts typically have a sodium contribution and a reduction of the content melting salt therefore makes it possible to reduce the total sodium content of the resulting processed cheese. The MCI used to at least partially replace natural cheese also has a lower sodium contribution than natural cheese and the present invention therefore offers a new approach for producing tasty, low sodium processed cheeses.

Thus, an aspect of the invention pertains to a method of preparing a processed cheese which preferably comprises sodium in an amount of at most 1.5% w/w, which method comprises the steps of:

a) providing a dairy mixture comprising water, melted fat, a micellar casein isolate (MCI), sodium chloride, and a melting salt, the dairy mixture having a pH in the range of 5.0-6.5, and wherein the MCI preferably contributes with at least 35% w/w of the protein of the dairy mixture, and wherein the dairy mixture preferably comprises sodium in an amount of at most 1.5% w/w,

b) subjecting the dairy mixture to heat treatment at a temperature of 80-150 degrees C. for a period of 2 seconds-10 minutes,

c) filling the heated dairy mixture in a suitable container, preferably at a temperature of 35-90 degrees C., thereby obtaining a packaged dairy mixture, and

d) optionally, storing the packaged dairy mixture for at least 1 day, preferably at a temperature of 2-40 degrees C.

In some preferred embodiments of the invention the method is a method of preparing a processed cheese which method comprises the steps of:

a) providing a dairy mixture comprising water, melted fat, a micellar casein isolate, sodium chloride, and a melting salt, the dairy mixture having a pH in the range of 5.0-6.5,

b) subjecting the dairy mixture to heat treatment at a temperature of 80-150 degrees C. for a period of 2 seconds-10 minutes,

c) filling the heated dairy mixture in a suitable container, preferably at a temperature of 35-90 degrees C., thereby obtaining a packaged dairy mixture, and

d) optionally, storing the packaged dairy mixture for at least 1 day, preferably at a temperature of 2-40 degrees C.,

e) optionally, cutting the packaged dairy mixture thereby obtaining a cut dairy mixture,

wherein the processed cheese is the packaged dairy mixture obtained from step c) or d) or the cut, packaged dairy mixture of step e).

Another aspect of the invention pertains to a processed cheese comprising sodium in an amount of at most 1.5% w/w and having:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a solids content of 25-65% w/w, more preferably 30-60% w/w, and most preferably 35-55% w/w, and
a pH of 5.0-6.5.

Yet an aspect of the invention pertains to the use of a micellar casein isolate for one or more of:
For producing a processed cheese and using the MCI as an ingredient, preferably contributing with at least 35% w/w of the protein of the processed cheese, more preferably at least 50% w/w, even more preferably at least 70% w/w and most preferably at least 95% w/w of the protein of the processed cheese,
At least partially replacing the amount of the natural cheese used in a processed cheese,
Reducing the amount of melting salt required in a processed cheese by using the MCI as an ingredient in the processed cheese,
Reducing the content of sodium of a processed cheese by using the MCI as an ingredient in the processed cheese
Producing a processed cheese comprising sodium in an amount of at most 1.5% w/w, and more preferably at most 1.3% w/w, even more preferably at most 1.0 and most preferably at most 0.7% w/w, and
Increasing the salty taste per mg sodium of a processed cheese.

### DETAILED DESCRIPTION

An aspect of the invention pertains to a method of preparing a processed cheese which preferably comprises sodium in an amount of at most 1.5% w/w, which method comprises the steps of:

a) providing a dairy mixture comprising water, melted fat, a micellar casein isolate (MCI), sodium chloride, and a melting salt, the dairy mixture having a pH in the range of 5.0-6.5, and wherein the MCI preferably contributes with at least 35% w/w of the protein of the dairy mixture, and wherein the dairy mixture preferably comprises sodium in an amount of at most 1.5% w/w,

b) subjecting the dairy mixture to heat treatment at a temperature of 80-150 degrees C. for a period of 2 seconds-10 minutes,

c) filling the heated dairy mixture in a suitable container, preferably at a temperature of 35-90 degrees C., thereby obtaining a packaged dairy mixture, and

d) optionally, storing the packaged dairy mixture for at least 1 day, preferably at a temperature of 2-40 degrees C.

In some preferred embodiments of the invention the method furthermore comprises a step e) of cutting the dairy mixture obtained from step c) or step d) thereby obtaining a cut dairy mixture.

The method results in a processed cheese which e.g. may be:
the packaged dairy mixture obtained from step c),
the packaged dairy mixture obtained from step d) or
the cut dairy mixture of step e).

In some preferred embodiments of the invention the processed cheese is the packaged dairy mixture obtained from step c).

In other preferred embodiments of the invention the processed cheese is the packaged dairy mixture obtained from step d).

In further preferred embodiments of the invention the processed cheese is the cut dairy mixture of step e).

An aspect of the invention pertains to a method of preparing a processed cheese which method comprises the steps of:

a) providing a dairy mixture comprising water, melted fat, a micellar casein isolate (MCI), sodium chloride, and a melting salt, the dairy mixture having a pH in the range of 5.0-6.5,

b) subjecting the dairy mixture to heat treatment at a temperature of 80-150 degrees C. for a period of 2 seconds-10 minutes,

c) filling the heat-treated dairy mixture in a suitable container, preferably at a temperature of 35-90 degrees C., thereby obtaining a packaged dairy mixture, and

d) optionally, storing the packaged dairy mixture for at least 1 day, preferably at a temperature of 2-40 degrees C.,

e) optionally, cutting the packaged dairy mixture thereby obtaining a cut dairy mixture,

wherein the processed cheese is the packaged dairy mixture obtained from step c) or d) or the cut, packaged dairy mixture of step e).

In the context of the present invention the term “processed cheese” pertains to cheese products prepared by heat-treating a mixture comprising melting salts, water, and natural cheese and/or micellar casein isolate, typically under shear. Traditional processed cheese uses natural cheese as a major protein source but the present invention makes it possible to prepare processed cheese with only a small amount of natural cheese and even without natural cheese.

The term “melting salt” is well-known in the art of processed cheese and may also be referred to as “emulsifying salt”. Melting salts are salts of calcium chelating molecules such as e.g. citrate, tartrate and/or phosphate and e.g. in the form of sodium and/or potassium salts of citrate, tartrate and/or phosphate. The phosphate is preferably orthophosphate, pyrophosphate, or metaphosphate.

In the context of the present invention the term “micellar casein isolate” or “MCI” pertains to an isolate of casein micelles from a milk source, typically skimmed milk, and contains at least 60% w/w protein relative to total solids and casein in an amount of at least 90% w/w relative to total protein. An MCI is typically prepared by microfiltration of milk using a membrane that retains casein micelles but allows for the passage of whey protein. The obtained microfiltration retentate is enriched with respect to casein micelles and may be subjected to further purification by microfiltration/diafiltration. The retentate may be used directly as a liquid MCI or it may be dried, preferably by spray-drying, and used as an MCI powder.

In some preferred embodiments of the present invention the micellar casein isolate of the dairy mixture is provided in the form of a micellar casein isolate powder.

In some preferred embodiments of the present invention the micellar casein isolate of the dairy mixture is provided in the form of a liquid micellar casein isolate.

In some preferred embodiments of the present invention the MCI contributes with at least 20% w/w of the protein of the dairy mixture, more preferably at least 25% w/w, even more preferably at least 30% w/w, and most preferably at least 35% w/w.

In other preferred embodiments of the present invention the mci contributes with at least 50% w/w of the protein of the dairy mixture, more preferably at least 70% w/w, even more preferably at least 90% w/w, and most preferably at least 95% w/w.

In some particularly preferred embodiments of the invention the mci contributes with substantially all protein of dairy mixture.

In some preferred embodiments of the present invention, e.g. if the dairy mixture contains cheese and/or other protein sources in addition to the MCI, the MCI contributes with 40-90% w/w of the protein of the dairy mixture, more preferably 44-85% w/w, even more preferably 48-80% w/w, and most preferably 50-75% w/w.

In some preferred embodiments of the present invention the micellar casein isolate has a weight ratio between sodium and protein of at most 0.0057, more preferably at most 0.0023, even more preferably at most 0.0011, and most preferably at most 0.00057

In some preferred embodiments of the present invention the micellar casein isolate has a weight ratio between potassium and protein of at most 0.011, more preferably at most 0.0057, even more preferably at most 0.0034, and most preferably at most 0.0011.

In some preferred embodiments of the present invention the micellar casein isolate has a weight ratio between calcium and protein of at most 0.046, more preferably at most 0.034, even more preferably at most 0.029, and most preferably at most 0.017.

It is particularly preferred that the MCI is produced organically and is an organic ingredient and hence suitable to replace organic natural cheese in organic processed cheeses. In some preferred embodiments of the present invention the processed cheese is an organic processed cheese.

The dairy mixture always comprises protein and in some preferred embodiments of the present invention the dairy mixture has a protein content of 7-35% w/w, more preferably 9-30% w/w, and most preferably 11-25% w/w.

In other preferred embodiments of the present invention the dairy mixture has a protein content of 7-30% w/w, more preferably 9-25% w/w, and most preferably 11-20% w/w.

It is preferred that at least 50% w/w of the protein of the dairy mixture, and equally of the processed cheese, is milk protein and provided by one or more milk protein sources incl. MCI and optionally also cheese.

The term “milk protein” pertains to one or more proteins derivable from mammal milk and covers both individual milk protein species such as individual milk serum or whey proteins or caseins and the complete milk protein fraction of milk, milk serum or whey. In addition to MCI, useful sources of milk protein include cheese, milk and various dairy-based protein-containing powders.

The milk protein of both the dairy mixture and processed cheese is preferably milk protein from cow, sheep, goat, buffalo, camel, llama, mare and/or deer. Milk protein from bovine (cow) milk is particularly preferred.

In some preferred embodiments of the present invention the dairy mixture and the processed cheese contain vegetable protein in addition to milk protein.

In some preferred embodiments of the present invention the dairy mixture comprises native whey protein in an amount of at most 10% w/w relative to total protein, more preferably at most 8% w/w, even more preferably at most 5% w/w, and most preferably at most 2% w/w.

The amount of native whey protein of the dairy mixture can be measured by precipitating caseins and denatured whey proteins by acidification to pH 4.6 and subsequently quantifying the native whey proteins that remain in the supernatant by quantitative HPLC.

The present inventors have observed that by lowering the content of native whey protein in the dairy mixture the resulting processed cheese becomes less sticky at 2-25 degrees C. A reduced stickiness is often a desirable processed cheese feature, particularly if provided in the form of processed cheese slices.

In some preferred embodiments of the present invention the dairy mixture comprises caseinomacropeptide in an amount of at most 8% w/w relative to total protein, more preferably at most 6% w/w, even more preferably at most 3% w/w, and most preferably at most 1% w/w.

In some preferred embodiments of the present invention the dairy mixture comprises casein in an amount of at least 90% w/w relative to total protein, more preferably at least 92% w/w, even more preferably at least 95% w/w, and most preferably at least 98% w/w.

The natural cheeses that are used for production of conventional processed cheese have typically been prepared by renneting which involves enzymatic hydrolysis of kappa casein into para-kappa casein. In the present invention at least some of the cheese of conventional processed cheese has been replaced with MCI in which kappa casein is still intact. Therefore, in some preferred embodiments of the present invention the dairy mixture comprises kappa casein in an amount of at least 1% w/w relative to total protein, more preferably at least 5% w/w, even more preferably at least 8% w/w, and most preferably at least 10% w/w.

Preferably the dairy mixture comprises kappa casein in an amount of 1-30% w/w relative to total protein, more preferably 3-20% w/w, even more preferably 5-15% w/w, and most preferably 10-13% w/w.

It is for example preferred that the dairy mixture comprises kappa casein in an amount of 3-30% w/w relative to total protein.

In some preferred embodiments of the present invention the dairy mixture comprises essentially no para-kappa casein.

The dairy mixture contains casein and may furthermore contain whey protein. In some preferred embodiments of the present invention the dairy mixture has a weight ratio between whey protein and casein of at most 0.5, more preferably at most 0.1, even more preferably at most 0.05, and most preferably at most 0.02.

In some preferred embodiments of the present invention the dairy mixture furthermore comprises cheese.

The cheese used in the present invention is preferably natural cheese and is preferably prepared by enzymatic coagulation of milk, preferably using one or more suitable rennet enzymes. Alternatively or additionally the coagulation may also involve acidification.

In some preferred embodiments of the invention the cheese comprises or even consists of cheese(s) that are prepared by rennet treatment of cheese milk, such as e.g. Colby cheese, Cheddar cheese, Gouda cheese, Danbo cheese, Swiss cheese, Mozzarella cheese, or a combination thereof.

In other preferred embodiments of the invention the cheese comprises or even consists of cheese that is prepared by acidification, and optionally also rennet treatment, of cheese milk, such as e.g. cream cheese, fromage frais, fromage blanc, or a combination thereof.

The use of cream cheese is particularly preferred, thus in some preferred embodiments of the invention the cheese comprises or even consists of cream cheese.

In some preferred embodiments of the invention the cheese of the dairy mixture comprises or even consists of un-aged cheese.

Preferably, cheese contributes with at most 80% w/w of the protein of the dairy mixture, more preferably at most 75% w/w, even more preferably at most 70% w/w, and most preferably at most 65% w/w.

More preferably, cheese contributes with at most 50% w/w of the protein of the dairy mixture, more preferably at most 40% w/w, even more preferably at most 10% w/w, and most preferably at most 5% w/w.

In some preferred embodiments of the present invention cheese contributes with at most 40% w/w of the dairy mixture, more preferably at most 35% w/w, even more preferably at most 30% w/w, and most preferably at most 25% w/w.

More preferably, cheese contributes with at most 20% w/w of the dairy mixture, more preferably at most 15% w/w, even more preferably at most 10% w/w, and most preferably at most 5% w/w.

In yet other preferred embodiments of the present invention the dairy mixture does not contain cheese.

In the context of the present invention the term “fat source” pertains to a composition that contains fat in an amount of at least 60% w/w. The terms “fat” and “oil” are used interchangeable and cover both fats that are liquid at room temperature and fats that are solid or semi-solid at room temperature.

In some preferred embodiments of the present invention the dairy mixture of step a) comprises one or more of the following fat sources: butter, AMF, butter oil, whey fat, vegetable oil, and/or a mixture thereof.

In some preferred embodiments of the present invention the dairy mixture has a fat content of 5-40% w/w, more preferably 8-35% w/w, and most preferably 10-30% w/w.

In other preferred embodiments of the present invention the dairy mixture has a fat content of 10-40% w/w, more preferably 15-35% w/w, and most preferably 20-30% w/w.

It should be noted that other ingredients than the fat source(s) can contribute to the fat content of the dairy mixture. Both MCI and cheese typically contains some fat.

The dairy mixture typically contains at least some carbohydrate and the desired amount often depends on the sensory characteristics that the resulting processed cheese should have. In some preferred embodiments of the present invention the dairy mixture has a carbohydrate content of at most 15% w/w, more preferably at most 10% w/w, and most preferably at most 5% w/w.

In some preferred embodiments of the invention the dairy mixture has a carbohydrate content in the range of 4-15% w/w, more preferably 6-15% w/w, even more preferably 8-15% w/w; and most preferably 10-15%.

The dairy mixture may contain other protein sources in addition to MCI and cheese and such other protein sources may include both sources of animal protein and/or sources of vegetable protein.

In some preferred embodiments of the present invention the dairy mixture furthermore comprises one or more of the following protein sources: skim milk powder, whole milk powder, low-lactose milk powder, lactose-free milk powder, buttermilk powder, ultrafiltered milk powder, reconstituted recombined milk powder, whey powder, whey protein concentrate (WPC), whey protein isolate (WPI) and serum protein concentrate (SPC), plant proteins and any mixtures thereof.

Melting salts are used in the dairy mixture to obtain the right texture of the final processed cheese. In some preferred embodiments of the present invention the melting salt of the dairy mixture comprises one or more melting salts selected from the group consisting of monosodium phosphate, disodium phosphate, dipotassium phosphate, trisodium phosphate, sodium, sodium acid pyrophosphate, tetrasodium pyrophosphate, sodium aluminium phosphate, sodium citrate, potassium citrate, calcium citrate, sodium tartrate and sodium potassium tartrate and any mixtures thereof.

Preferably the melting salt of the dairy mixture comprises one or more salts selected from the group consisting of monosodium phosphate, disodium phosphate, dipotassium phosphate, trisodium phosphate, sodium metaphosphate, sodium acid pyrophosphate, tetrasodium pyrophosphate, sodium aluminium phosphate, sodium citrate, potassium citrate, calcium citrate, sodium tartrate and sodium potassium tartrate and any mixtures thereof.

Preferably, the melting salt of the dairy mixture is selected from the group consisting of monosodium phosphate, disodium phosphate, dipotassium phosphate, trisodium phosphate, sodium metaphosphate, sodium acid pyrophosphate, tetrasodium pyrophosphate, sodium aluminium phosphate, sodium citrate, potassium citrate, calcium citrate, sodium tartrate and sodium potassium tartrate and any mixtures thereof.

In some preferred embodiments of the present invention the dairy mixture comprises melting salt in an amount of 0.2-4% w/w, more preferably 0.5-3.5% w/w, even more preferably 0.7-3.2% w/w, and most preferably 0.8-3.0% w/w.

In some preferred embodiments of the present invention the dairy mixture comprises melting salt in an amount of 0.2-3.0% w/w, more preferably 0.5-2.5% w/w, even more preferably 0.6-1.5% w/w, and most preferably 0.7-1.0% w/w.

The pH of the dairy mixture is preferably in the range of 5.0-6.5. More preferably, the pH of the dairy mixture is in the range of 5.4-6.0, and most preferably in the range of 5.5-5.8. The pH may e.g. be adjusted in step v) of the preferred process for providing the dairy mixture.

In some preferred embodiments of the present invention dairy mixture furthermore comprises one or more acidifier(s), preferably selected from the group consisting of Glucono Delta-Lactone (GDL), citric acid, phosphoric acid, lactic acid, lemon juice, lime juice and any mixtures thereof. The acidifier may e.g. be added in step v) of the preferred process for providing the dairy mixture.

A benefit of the present processed cheese is that it has a low sodium content and a low sodium content is equally a characteristics of the dairy mixture. In some preferred embodiments of the present invention the dairy mixture has a content of sodium of at most 1.5% w/w, more preferably at most 1.3% w/w, even more preferably at most 1.2% w/w, and most preferably at most 0.6.

Preferably, the dairy mixture has a content of sodium in the range of 0.1-1.5% w/w, more preferably 0.4-1.3% w/w, and most preferably 0.5-1.2% w/w.

In other preferred embodiments of the present invention the dairy mixture has a content of sodium in the range of 0.1-1.0% w/w, more preferably 0.2-0.9% w/w, even more preferably 0.3-0.7% w/w, and most preferably 0.4-0.6% w/w.

In some preferred embodiments of the present invention the dairy mixture has a content of potassium of at most 1% w/w, more preferably at most 0.6% w/w, even more preferably at most 0.4% w/w, and most preferably at most 0.2.

Preferably, the dairy mixture has a content of potassium in the range of 0.01-1% w/w, more preferably 0.02-0.8% w/w, even more preferably 0.03-0.6% w/w, and most preferably 0.05-0.3% w/w.

In some preferred embodiments of the present invention the dairy mixture has a content of calcium of at most 1.0% w/w, more preferably at most 0.8% w/w, and most preferably at most 0.6.

Preferably, the dairy mixture has a content of calcium in the range of 0.1-1.0% w/w, more preferably 0.2-0.8% w/w, and most preferably 0.3-0.6% w/w.

In addition to calcium the dairy mixture typically comprises magnesium and other divalent metal cations which are inherent to milk preparations but preferably contains each of these in a concentration which is at most 50% w/w of the concentration of calcium, more preferably at most 30% w/w of the concentration of calcium, most preferred at most 20% w/w of the concentration of calcium.

The dairy mixture preferably has a concentration of magnesium which is at most 50% w/w of the concentration of calcium, more preferably at most 30% w/w of the concentration of calcium, most preferred at most 20% w/w of the concentration of calcium.

In some preferred embodiments of the invention the dairy mixture has a solids content of 25-65% w/w, more preferably 30-60% w/w, and most preferably 35-55% w/w.

The dairy mixture may furthermore contain one or more flavouring agents to provide the processed cheese with the desired flavour. Any suitable flavouring agent may be used. The dairy mixture may for example contain one or more fruit flavouring agents, such as e.g. one or more of banana flavour, strawberry flavour, orange flavour, lemon flavour, lime flavour, pineapple flavour, kiwi flavour, papaya flavour, apple flavour, pear flavour, peach flavour, raspberry flavour, cherry flavour, cranberry flavour, blackcurrant flavour, grape fruit flavour, boysenberry flavour, blackberry flavour, fig flavour, redcurrant flavour, gooseberry flavour, pomegranate flavour and/or melon flavour. Alternatively or additionally, the dairy mixture may contain caramel flavour and/or vanilla flavour.

The dairy mixture may furthermore contain one or more colouring agents.

In some preferred embodiments of the present invention the dairy mixture has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a sodium content of at most 1.5% w/w, more preferably at most 1.3% w/w, and most preferably at most 1.2% w/w,
a solids content of 25-65% w/w, more preferably 30-60% w/w, and most preferably 35-55% w/w.

In other preferred embodiments of the present invention the dairy mixture has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a sodium content of 0.1-1.5% w/w, more preferably 0.4-1.3% w/w, and most preferably 0.5-1.2% w/w,
a solids content of 25-65% w/w, more preferably 30-60% w/w, and most preferably 35-55% w/w,

wherein the MCI contributes with at least 35% w/w of the protein of the dairy mixture, more preferably at least 50% w/w, and most preferably at least 70% w/w.

In further preferred embodiments of the present invention the dairy mixture has:
a fat content of 5-40% w/w, more preferably 8-35% w/w, and most preferably 10-30%
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a sodium content of 0.1-1.0% w/w, more preferably 0.2-0.9% w/w, and most preferably 0.4-0.6% w/w,
a solids content of 25-65% w/w, more preferably 30-60% w/w, and most preferably 35-55% w/w,

wherein the MCI contributes with at least 35% w/w of the protein of the dairy mixture, more preferably at least 50% w/w, and most preferably at least 70% w/w.

In other preferred embodiments of the present invention, the dairy mixture has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of 4-15% w/w, more preferably 8-15% w/w, and most preferably 10-15% w/w,
a sodium content of 0.1-1.0% w/w, more preferably 0.2-0.9% w/w, and most preferably 0.4-0.6% w/w,
preferably, one or more flavouring agent(s), more preferably one or more fruit flavouring agent(s) and/or caramel flavour,
a solids content of 25-65% w/w, more preferably 30-60% w/w, and most preferably 35-55% w/w.

In further preferred embodiments of the present invention, the dairy mixture has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of 4-15% w/w, more preferably 8-15% w/w, and most preferably 10-15% w/w,
a sodium content of 0.1-1.0% w/w, more preferably 0.2-0.9% w/w, and most preferably 0.4-0.6% w/w,
one or more flavouring agent(s), more preferably one or more fruit flavouring agent(s) and/or caramel flavour,
a solids content of 25-65% w/w, more preferably 30-60% w/w, and most preferably 35-55% w/w, and

wherein the MCI contributes with at least 35% w/w of the protein of the dairy mixture, more preferably at least 50% w/w, and most preferably at least 80% w/w.

It is particularly preferred that the processed cheese is an organic processed cheese and it is therefore equally preferred that ingredients of the dairy mixture are organic.

The dairy mixture may be prepared and hence provided in a number of different ways by combining the appropriate ingredients.

In some preferred embodiments of the present invention the dairy mixture is provided by:

i) providing a composition comprising a fat source, water, and optionally also cheese,

ii) subjecting the composition obtained in step i) to heating to melt the fat, preferably to a temperature of 30-75 degrees C., most preferably 30-50 degrees C.,

iii) adding at least micellar casein isolate and melting salt, and optionally also NaCl, to the heated composition obtained in step ii),

iv) mixing the composition obtained in step iii),

v) adjusting pH of the composition obtained in step d to about 5.0-6.5, most preferably 5.5-6.0 if the pH is not already in this range, e.g. by adding an acidifier.

Additional protein sources are preferably added in step iii) or alternatively in step i) and/or step ii).

The mixing of step iv) is preferably thorough mixing and preferably provides a uniform distribution of the mixed ingredients throughout the resulting dairy mixture.

If the above sequence of steps is used to provide the dairy mixture, the dairy mixture is the composition obtained from step v) if pH adjustment is required or from step iv) if the pH is already in the range of 5.0-6.5 after the thorough mixing of step iv) and not.

In some preferred embodiments of the present invention the dairy mixture is prepared by mixing:
MCI in an amount of 3-40% w/w relative to the weight of the dairy mixture, more preferably 4-35% w/w, even more preferably 10-30% w/w relative to the weight of the dairy mixture, and most preferably 12-24% w/w,
Natural cheese in an amount of 0-40% w/w relative to the weight of the dairy mixture, more preferably 5-38% w/w, even more preferably 10-36% w/w, and most preferably 12-34%
Fat source, preferably butter, in an amount of 5-40% w/w relative to the weight of the dairy mixture, more preferably 8-35% w/w, even more preferably 10-30% w/w, and most preferably 12-25% w/w
Melting salt in an amount of 0.2-4% w/w relative to the weight of the dairy mixture, more preferably 0.5-3.5% w/w, even more preferably 0.7-3.2% w/w, and most preferably 0.8-3.0% w/w,
Sodium chloride in an amount of 0-1.4% w/w relative to the weight of the dairy mixture, more preferably 0.2-1.2% w/w, even more preferably 0.4-1.1% w/w, and most preferably 0.5-1.0% w/w,
optionally, one or more further ingredients preferably including a food acid, and
water, preferably in an amount of 5-75% w/w, more preferably 10-65% w/w, even more preferably 20-55% w/w relative to the weight of the dairy mixture, and most preferably; 25-50% w/w.

In other preferred embodiments of the present invention the dairy mixture is prepared by mixing:
MCI in an amount of 3-40% w/w relative to the weight of the dairy mixture, more preferably 4-35% w/w, even more preferably 10-30% w/w relative to the weight of the dairy mixture, and most preferably 12-24% w/w,
Natural cheese in an amount of 0-40% w/w relative to the weight of the dairy mixture, more preferably 0-20% w/w, even more preferably 0-10% w/w, and most preferably 0-5% w/w,
Fat source, preferably butter, in an amount of 5-40% w/w relative to the weight of the dairy mixture, more preferably 8-35% w/w, even more preferably 10-30% w/w, and most preferably 12-25% w/w
Melting salt in an amount of 0.2-4% w/w relative to the weight of the dairy mixture, more preferably 0.5-3.5% w/w, even more preferably 0.7-3.2% w/w, and most preferably 0.8-3.0% w/w,
Sodium chloride in an amount of 0-1.4% w/w relative to the weight of the dairy mixture, more preferably 0.2-1.2% w/w, even more preferably 0.4-1.1% w/w, and most preferably 0.5-1.0% w/w,
optionally, one or more further ingredients preferably including a food acid, and
water, preferably in an amount of 5-75% w/w, more preferably 10-65% w/w, even more preferably 20-55% w/w relative to the weight of the dairy mixture, and most preferably; 25-50% w/w.

Step b) involves heat-treating the dairy mixture to a temperature of at least 80 degrees C.

The present inventors have found MCI to improve the heat stability of the dairy mixture and therefore makes sterilising heat-treatments possible.

In some preferred embodiments of the present invention the heat treatment of step b) involves:
heating the dairy mixture to a temperature of 90-98 degrees C., most preferably 94-96 degrees C., for a duration of 4 to 8 minutes, most preferably 5-6 minutes, or
heating the dairy mixture to a temperature of 120-145 degrees C., for a duration of 2 to 30 seconds.

In other preferred embodiments of the present invention the heat-treatment of step b) involves heating the dairy mixture to a temperature of at least 100 degrees C., more preferably at least 120 degrees C. and most preferably at least 140 degrees C. for a duration sufficient to sterilise the dairy mixture. Preferably the dairy mixture is sterilised using a heat-treatment where the dairy mixture is heated to a temperature in the range 120-145 degrees C. for a duration sufficient to obtain sterility, typically of 2 to 30 seconds.

In some particularly preferred embodiments of the present invention the heat-treated dairy mixture is sterile.

In the context of the present invention, the term “sterile” means that the sterile composition or product in question does not contain any viable microorganisms and therefore is devoid of microbial growth during storage at room temperature. A composition that has been sterilised is sterile.

The dairy mixture is often at least partially cooled after the heat-treatment, particularly is temperatures above 95 degrees C. have been employed. The heat-treated dairy mixture is preferably cooled to a temperature in the range of 35-95 degrees C., and more preferably 40-90 degrees C. If the subsequent filling is supposed to use hot-filling the heat-treated dairy mixture is preferably cooled to 70-95 degrees C. and most preferably 80-90 degrees C. The cooling may e.g. involve flash cooling which is preferred when heating temperature above 100 degrees C. are used or indirect cooling which is preferred for temperatures of at most 100 degrees C.

It is furthermore particularly preferred that the heat treatment of step b) is performed under shear and/or is followed by a shearing step to ensure that the final processed cheese is a smooth, uniform product. The shearing step is also known as a creaming step and is well-known to the skilled person. The shearing preferably takes place at a temperature in the range of 35-95 degrees C., more preferably 40-90 degrees C. and most preferably 70-90 degrees C.

Step c) of the method involves filling the heat-treated dairy mixture into one or more suitable containers.

The temperature of the dairy mixture during filling is preferably sufficiently high to keep the dairy mixture pumpable, typically at least 35 degrees C. and preferably in the range of 35-90 degrees C.

In some preferred embodiments of the present invention the filling temperature of step c), i.e. the temperature of the heat-treated dairy mixture during filling, is in the range of 70-90 degrees C., and most preferably in the range of 82-88 degrees C.

In some preferred embodiments of the present invention the filling of step c) is aseptic filling and the containers are sterile containers which are sealed aseptically after filling. This is particularly preferred if the heat-treated dairy mixture is sterile or nearly sterile and provides a long shelf-life of the processed cheese.

The container may be the final container which holds the processed cheese until the consumer opens the container to consume the processed cheese. Alternatively, the container may be an intermediary container which holds the processed cheese until it is subjected to a further processing step such as a cutting step in which the processed cheese e.g. is cut into slices.

Processed cheese is preferably present in the form of a spread, a block, individually wrapped slices, or slices arranged slice-on-slice.

In further preferred embodiments of the present invention the processed cheese is in the form of processed cheese spread, i.e. a processed cheese sufficiently soft to be spread over a piece of bread.

In even further preferred embodiments of the present invention the processed cheese is in the form of a block of processed cheese.

It is well-known to the skilled person how to control the texture and viscosity of the processed cheese e.g. by controlling the solids content of the dairy mixture and the choice of melting salts.

In some preferred embodiments of the present invention the packaged processed cheese is stored for some time, preferably at least 1 day, and most preferably at least 3 days to allow the processed cheese to set.

In some preferred embodiments of the present invention the storing temperature in step d) is 2-40 degrees C., more preferably 2-8 degrees C. or equally preferably 20-40 degrees C.

In some preferred embodiments of the present invention the method furthermore comprises a step of cutting the packaged dairy mixture obtained from step c) or d). The packaged dairy mixture is preferably cut into slices. As will be understood, the packaged dairy mixture is preferably removed from the container before the cutting.

The method of the present invention is surprisingly well-suited for production of processed cheese in the form of slices arranged slice-on-slice, i.e. stacked so that each slice is in direct contact with another slice without a separating plastic film. This slice arrangement requires processed cheese slices with a surface that sets rapidly after slicing to avoid that the slices stick together and become impossible to separate. The present inventors have found that the processed cheese of the invention has this ability and therefore is well-suited for the slice-on-slice arrangement.

In some preferred embodiments of the present invention the processed cheese is in the form of slices of processed cheese arranged slice-on-slice. Step e) therefore preferably involves cutting the packaged dairy mixture, i.e. the dairy mixture obtained from step c) or step d), into slices and arranging them slice-on-slice.

In other preferred embodiments of the present invention the processed cheese is in the form of individually wrapped slices of processed cheese. Step e) therefore preferably involves cutting the dairy mixture obtained from step c) or step d) into slices and wrapping the slices individually.

The steps of present method are perform in the sequence a), b), c). If step d) is included the sequence of steps is a), b), c), d). If step e) is included the sequence is a), b), c), d), e) if step d) is included and a), b), c), e) is step d) is omitted.

Another aspect of the invention pertains to a processed cheese comprising sodium in an amount of at most 1.5% w/w and having:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a solids content of 25-65% w/w, more preferably 30-60% w/w, and most preferably 35-55% w/w, and
a pH of 5.0-6.5, more preferably 5.4-6.0, and most preferably 5.5-5.8.

In some preferred embodiments of the invention the processed cheese comprising sodium in an amount of 0.1-1.5% w/w, more preferably 0.4-1.3% w/w, and most preferably 0.5-1.2% w/w and has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a solids content of 25-65% w/w, more preferably 30-60% w/w, and most preferably 35-55% w/w, and
a pH of 5.0-6.5, more preferably 5.4-6.0, and most preferably 5.5-5.8.

In other preferred embodiments of the invention the processed cheese comprising sodium in an amount of 0.1-1.0% w/w, more preferably 0.2-0.9% w/w, and most preferably 0.4-0.6% w/w, and has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a solids content of 25-65% w/w, more preferably 30-60% w/w, and most preferably 35-55% w/w, and
a pH of 5.0-6.5, more preferably 5.4-6.0, and most preferably 5.5-5.8.

The content of macronutrients and minerals of the processed cheese is essentially the same in the dairy mixture. Features and embodiments described in the context of the dairy mixture therefore equally apply to the processed cheese unless it is evident that the heat-treatment alters the feature in question.

In some preferred embodiments of the invention the processed cheese has a carbohydrate content in the range of 4-15% w/w, more preferably 6-15% w/w, even more preferably 8-15% w/w; and most preferably 10-15%.

It may for example be preferred that the processed cheese comprises sodium in an amount of at most 1.5% w/w and has:
a fat content of 5-40% w/w, more preferably 8-35% w/w, and most preferably 10-30% w/w,
a protein content of 7-35% w/w, more preferably 10-30% w/w, and most preferably 12-25
a carbohydrate content of 4-15% w/w, more preferably 8-15% w/w, and most preferably 10-15% w/w,
a solids content of 25-65% w/w, more preferably 30-60% w/w, and most preferably 35-55% w/w, and
a pH of 5.0-6.5.

Preferably, the processed cheese has a sodium content of 0.1-1.5% w/w, more preferably 0.4-1.3% w/w, and most preferably 0.5-1.2% w/w

Alternatively, but also preferably the processed cheese may have a content of sodium in the range of 0.1-1.0% w/w, more preferably 0.2-0.9% w/w, even more preferably 0.3-0.7% w/w, and most preferably 0.4-0.6% w/w.

The present inventors have discovered that the processed cheese of the present invention surprisingly provides more salty taste per weight percent sodium than a processed cheese having a comparable sodium content but which is based on natural cheese only.

Potassium is frequently used for sodium replacement but has an unpleasant bitter, metallic taste if used in too high concentrations. It is therefore often preferred that the processed cheese of the invention and therefore also the dairy mixture has a limited content of potassium.

In some preferred embodiments of the present invention the processed cheese has a content of potassium of at most 1% w/w, more preferably at most 0.6% w/w, even more preferably at most 0.4% w/w, and most preferably at most 0.2.

Preferably, the processed cheese has a content of potassium in the range of 0.01-1% w/w, more preferably 0.02-0.8% w/w, even more preferably 0.03-0.6% w/w, and most preferably 0.05-0.3% w/w.

In some preferred embodiments of the present invention the processed cheese has a content of calcium of at most 1.0% w/w, more preferably at most 0.8% w/w, and most preferably at most 0.6.

Preferably, the processed cheese has a content of calcium in the range of 0.1-1.0% w/w, more preferably 0.2-0.8% w/w, and most preferably 0.3-0.6% w/w.

In addition to calcium the processed cheese typically comprises magnesium and other divalent metal cations which are inherent to milk preparations but preferably contains each of these in a concentration which is at most 50% w/w of the concentration of calcium, more preferably at most 30% w/w of the concentration of calcium, most preferred at most 20% w/w of the concentration of calcium.

The processed cheese preferably has a concentration of magnesium which is at most 50% w/w of the concentration of calcium, more preferably at most 30% w/w of the concentration of calcium, most preferred at most 20% w/w of the concentration of calcium.

In some preferred embodiments of the present invention the processed cheese comprises melting salt in an amount of 0.2-4% w/w, more preferably 0.5-3.5% w/w, even more preferably 0.7-3.2% w/w, and most preferably 0.8-3.0% w/w.

In some preferred embodiments of the present invention the processed cheese comprises melting salt in an amount of 0.2-3.0% w/w, more preferably 0.5-2.5% w/w, even more preferably 0.6-1.5% w/w, and most preferably 0.7-1.0% w/w.

In some preferred embodiments of the present invention the processed cheese comprises kappa casein in an amount of at least 1% w/w relative to total protein, more preferably at least 3% w/w, even more preferably at least 5% w/w, and most preferably at least 10% w/w.

Preferably, the processed cheese comprises kappa casein in an amount of 1-30% w/w relative to total protein, more preferably 3-20% w/w, even more preferably 5-15% w/w, and most preferably 10-13% w/w.

It may for example be preferred that the processed cheese comprises kappa casein in an amount of 3-30% w/w relative to total protein.

In other preferred embodiments of the present invention the processed cheese comprises essentially no para-kappa casein. This typically is the case when no cheese has been used for producing the processed cheese.

In some preferred embodiments of the present invention the processed cheese has a weight ratio between whey protein and casein of at most 0.5, more preferably at most 0.1, even more preferably at most 0.05, and most preferably at most 0.02.

The pH of the processed cheese is preferably in the range of 5.0-6.5. More preferably, the pH of the dairy mixture is in the range of 5.4-6.0, most preferably in the range of 5.5-5.8.

In some preferred embodiments of the present invention the processed cheese is sterile. This is particularly useful for long shelf-life processed cheeses that can be stored at ambient temperature.

In some preferred embodiments of the present invention the processed cheese is an organic processed cheese.

In some particularly preferred embodiments of the present invention the processed cheese is obtainable by the method described herein.

Yet an aspect of the invention pertains to the use of a micellar casein isolate as defined herein for one or more of:
For producing a processed cheese and using the MCI as an ingredient, preferably contributing with at least 25% w/w of the protein of the processed cheese, more preferably at least 50% w/w, even more preferably at least 70% w/w and most preferably at least 95% w/w of the protein of the processed cheese,
At least partially replacing the amount of the natural cheese used in a processed cheese,
Reducing the amount of melting salt required in a processed cheese by using the MCI as an ingredient in the processed cheese,
Reducing the content of sodium of a processed cheese by using the MCI as an ingredient in the processed cheese
Producing a processed cheese comprising sodium in an amount of at most 1.5% w/w, and more preferably at most 1.3% w/w, even more preferably at most 1.0 and most preferably at most 0.7% w/w, and
Increasing the salty taste per mg sodium of a processed cheese.

Particularly preferred embodiments of the invention are described in the following numbered embodiments:

Numbered embodiment 1. A method of preparing a processed cheese which method comprises the steps of:

a) providing a dairy mixture comprising water, melted fat, a micellar casein isolate, sodium chloride, and a melting salt, the dairy mixture having a pH in the range of 5.0-6.5,

b) subjecting the dairy mixture to heat treatment at a temperature of 80-150 degrees C. for a period of 2 seconds-10 minutes,

c) filling the heated dairy mixture in a suitable container, preferably at a temperature of 35-90 degrees C., thereby obtaining a packaged dairy mixture, and

d) optionally, storing the packaged dairy mixture for at least 1 day, preferably at a temperature of 2-40 degrees C.,

e) optionally, cutting the packaged dairy mixture thereby obtaining a cut dairy mixture,

wherein the processed cheese is the packaged dairy mixture obtained from step c) or d) or the cut, packaged dairy mixture of step e).

Numbered embodiment 2. The method according to any of the preceding numbered embodiments, wherein the mci contributes with at least 20% w/w of the protein of the dairy mixture, more preferably at least 25% w/w, even more preferably at least 30% w/w, and most preferably at least 35% w/w.

Numbered embodiment 3. The method according to any of the preceding numbered embodiments, wherein the mci contributes with at least 50% w/w of the protein of the dairy mixture, more preferably at least 70% w/w, even more preferably at least 90% w/w, and most preferably at least 95% w/w.

Numbered embodiment 4. The method according to any of the preceding numbered embodiments, wherein the mci contributes with 40-90% w/w of the protein of the dairy mixture, more preferably 44-85% w/w, even more preferably 48-80% w/w, and most preferably 50-75% w/w.

Numbered embodiment 5. The method according to any one of the preceding numbered embodiments, wherein the micellar casein isolate has a weight ratio between sodium and protein of at most 0.0057, more preferably at most 0.0023, even more preferably at most 0.0011, and most preferably at most 0.00057

Numbered embodiment 6. The method according to any one of the preceding numbered embodiments, wherein the micellar casein isolate has a weight ratio between potassium and protein of at most 0.011, more preferably at most 0.0057, even more preferably at most 0.0034, and most preferably at most 0.0011.

Numbered embodiment 7. The method according to any one of the preceding numbered embodiments, wherein the micellar casein isolate has a weight ratio between calcium and protein of at most 0.046, more preferably at most 0.034, even more preferably at most 0.029, and most preferably at most 0.017.

Numbered embodiment 8. The method according to any one of the preceding numbered embodiments, wherein the dairy mixture has a protein content of 7-35% w/w, more preferably 9-30% w/w, and most preferably 11-25% w/w.

Numbered embodiment 9. The method according to any one of the preceding numbered embodiments, wherein the dairy mixture has a protein content of 7-30% w/w, more preferably 9-25% w/w, and most preferably 11-20% w/w.

Numbered embodiment 10. The method according to any one of the preceding numbered embodiments, wherein the dairy mixture comprises native whey protein in an amount of at most 10% w/w relative to total protein, more preferably at most 8% w/w, even more preferably at most 5% w/w, and most preferably at most 2% w/w.

Numbered embodiment 11. The method according to any one of the preceding numbered embodiments, wherein the dairy mixture comprises caseinomacropeptide in an amount of at most 8% w/w relative to total protein, more preferably at most 6% w/w, even more preferably at most 3% w/w, and most preferably at most 1% w/w.

Numbered embodiment 12. The method according to any one of the preceding numbered embodiments, wherein the dairy mixture comprises casein in an amount of at least 90% w/w relative to total protein, more preferably at least 92% w/w, even more preferably at least 95% w/w, and most preferably at least 98% w/w.

Numbered embodiment 13. The method according to any one of the preceding numbered embodiments, wherein the dairy mixture comprises kappa casein in an amount of at least 1% w/w relative to total protein, more preferably at least 3% w/w, even more preferably at least 5% w/w, and most preferably at least 10% w/w.

Numbered embodiment 14. The method according to any one of the preceding numbered embodiments, wherein the dairy mixture comprises kappa casein in an amount of 1-30% w/w relative to total protein, more preferably 3-20% w/w, even more preferably at least 5-15% w/w, and most preferably at least 10-13% w/w.

Numbered embodiment 15. The method according to any one of the preceding numbered embodiments, wherein the dairy mixture comprises essentially no para-kappa casein.

Numbered embodiment 16. The method according to any one of the preceding numbered embodiments, wherein the dairy mixture has a weight ratio between whey protein and casein of at most 0.5, more preferably at most 0.1, even more preferably at most 0.05, and most preferably at most 0.02.

Numbered embodiment 17. The method according to any of the preceding numbered embodiments, wherein the dairy mixture furthermore comprises cheese.

Numbered embodiment 18. The method according to any of the preceding numbered embodiments, wherein cheese contributes with at most 80% w/w of the protein of the dairy mixture, more preferably at most 75% w/w, even more preferably at most 70% w/w, and most preferably at most 65% w/w.

Numbered embodiment 19. The method according to any of the preceding numbered embodiments, wherein cheese contributes with at most 50% w/w of the protein of the dairy mixture, more preferably at most 40% w/w, even more preferably at most 10% w/w, and most preferably at most 5% w/w.

Numbered embodiment 20. The method according to any of the preceding numbered embodiments, wherein cheese contributes with at most 40% w/w of the dairy mixture, more preferably at most 35% w/w, even more preferably at most 30% w/w, and most preferably at most 25% w/w.

Numbered embodiment 21. The method according to any of the preceding numbered embodiments, wherein cheese contributes with at most 20% w/w of the dairy mixture, more preferably at most 15% w/w, even more preferably at most 10 w/w, and most preferably at most 5% w/w.

Numbered embodiment 22. The method according to any one of the preceding numbered embodiments, wherein the fat of the dairy mixture of step a) comprises one or more of the following sources: butter, AMF, butter oil, whey fat, vegetable oil, and/or a mixture thereof.

Numbered embodiment 23. The method according to any one of the preceding numbered embodiments, wherein the dairy mixture has a fat content of 5-40% w/w, more preferably 8-35% w/w, and most preferably 10-30% w/w.

Numbered embodiment 24. The method according to any one of the preceding numbered embodiments, wherein the dairy mixture has a fat content of 10-40% w/w, more preferably 15-35% w/w, and most preferably 20-30% w/w.

Numbered embodiment 25. The method according to any one of the preceding numbered embodiments wherein the dairy mixture furthermore has a carbohydrate content of at most 15% w/w, more preferably at most 10% w/w, and most preferably at most 5% w/w.

Numbered embodiment 26. The method according to any one of the preceding numbered embodiments, wherein the micellar casein isolate of the dairy mixture is provided in the form of powdered micellar casein isolate and/or liquid micellar casein isolate.

Numbered embodiment 27. The method according to any one of the preceding numbered embodiments, wherein the micellar casein isolate contains at least 60% protein relative to total solids and casein in an amount of at least 90% w/w relative to total protein.

Numbered embodiment 28. The method according to any of the preceding numbered embodiments, wherein the dairy mixture furthermore comprises skim milk powder, whole milk powder, low-lactose milk powder, lactose-free milk powder, buttermilk powder, ultrafiltered milk powder, reconstituted recombined milk powder, whey powder, whey protein concentrate (WPC), whey protein isolate (WPI) and serum protein concentrate (SPC), plant proteins and any mixtures thereof.

Numbered embodiment 29. The method according to any one of the preceding numbered embodiments, wherein the melting salt of the dairy mixture comprises one or more salts selected from the group consisting of monosodium phosphate, disodium phosphate, dipotassium phosphate, trisodium phosphate, sodium metaphosphate, sodium acid pyrophosphate, tetrasodium pyrophosphate, sodium aluminium phosphate, sodium citrate, potassium citrate, calcium citrate, sodium tartrate and sodium potassium tartrate and any mixtures thereof.

Numbered embodiment 30. The method according to any one of the preceding numbered embodiments, wherein the dairy mixture comprises melting salt in an amount of 0.2-4% w/w, more preferably 0.5-3.5% w/w, even more preferably 0.7-3.2% w/w, and most preferably 0.8-3.0% w/w.

Numbered embodiment 31. The method according to any one of the preceding numbered embodiments, wherein the dairy mixture has:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a sodium content of at most 1.5% w/w, more preferably at most 1.3% w/w, and most preferably at most 1.2% w/w,
a solids content of 25-65% w/w, more preferably 30-60% w/w, and most preferably 35-55% w/w.

Numbered embodiment 32. The method according to any one of the preceding numbered embodiments, wherein pH of the dairy mixture is 5.4-6.0, most preferably 5.5-5.8.

Numbered embodiment 33. The method according to any one of the preceding numbered embodiments, wherein the dairy mixture furthermore comprises one or more acidifier(s), preferably selected from the group consisting of Glucono Delta-Lactone (GDL), citric acid, phosphoric acid, lactic acid, lemon juice, lime juice and any mixtures thereof.

Numbered embodiment 34. The method according to any one of the preceding numbered embodiments, wherein the dairy mixture has a content of sodium of at most 1.5% w/w, more preferably at most 1.3% w/w, even more preferably at most 1.2% w/w, and most preferably at most 0.6.

Numbered embodiment 35. The method according to any one of the preceding numbered embodiments, wherein the dairy mixture has a content of sodium in the range of 0.1-1.5% w/w, more preferably 0.4-1.3% w/w, and most preferably 0.5-1.2% w/w.

Numbered embodiment 36. The method according to any one of the preceding numbered embodiments, wherein the dairy mixture has a content of sodium in the range of 0.1-1.0% w/w, more preferably 0.2-0.9% w/w, even more preferably 0.3-0.7% w/w, and most preferably 0.4-0.6% w/w.

Numbered embodiment 37. The method according to any one of the preceding numbered embodiments, wherein the dairy mixture has a content of potassium of at most 1% w/w, more preferably at most 0.6% w/w, even more preferably at most 0.4% w/w, and most preferably at most 0.2.

Numbered embodiment 38. The method according to any one of the preceding numbered embodiments, wherein the dairy mixture has a content of potassium in the range of 0.01-1% w/w, more preferably 0.02-0.8% w/w, even more preferably 0.03-0.6% w/w, and most preferably 0.05-0.3% w/w.

Numbered embodiment 39. The method according to any one of the preceding numbered embodiments, wherein the dairy mixture has a content of calcium of at most 1.0% w/w, more preferably at most 0.8% w/w, and most preferably at most 0.6.

Numbered embodiment 40. The method according to any one of the preceding numbered embodiments, wherein the dairy mixture has a content of calcium in the range of 0.1-1.0% w/w, more preferably 0.2-0.8% w/w, and most preferably 0.3-0.6% w/w.

Numbered embodiment 41. The method according to any one of the preceding numbered embodiments, wherein the heat treatment of step b) involves:
heating the dairy mixture to a temperature of 90-98 degrees C., most preferably 94-96 degrees C., for a duration of 4 to 8 minutes, most preferably 5-6 minutes, or
heating the dairy mixture to a temperature of 120-145 degrees C., for a duration of 2 to 30 seconds.

Numbered embodiment 42. The method according to any one of the preceding numbered embodiments, wherein the heat treatment of step b) is followed by a shearing.

Numbered embodiment 43. The method according to any one of the preceding numbered embodiments, wherein the filling temperature in step c) is in the range of 70-90 degrees C., and most preferably in the range of 82-88 degrees C.

Numbered embodiment 44. The method according to any one of the preceding numbered embodiments, wherein the storing temperature in step d) is 2-40 degrees C., more preferably 2-8 degrees C. or 20-40 degrees C.

Numbered embodiment 45. A processed cheese comprising sodium in an amount of at most 1.5% w/w and having:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a solids content of 25-65% w/w, more preferably 30-60% w/w, and most preferably 35-55% w/w, and
a pH of 5.0-6.5.

Numbered embodiment 46. The processed cheese according to numbered embodiment 45 having a sodium content of 0.1-1.5% w/w, more preferably 0.4-1.3% w/w, and most preferably 0.5-1.2% w/w

Numbered embodiment 47. The processed cheese according to numbered embodiment 45 having a content of sodium in the range of 0.1-1.0% w/w, more preferably 0.2-0.9% w/w, even more preferably 0.3-0.7% w/w, and most preferably 0.4-0.6% w/w.

Numbered embodiment 48. The processed cheese according to any one of the numbered embodiments 45-47 wherein the processed cheese comprises melting salt in an amount of 0.2-4% w/w, more preferably 0.5-3.5% w/w, even more preferably 0.7-3.2% w/w, and most preferably 0.8-3.0% w/w.

Numbered embodiment 49. The processed cheese according to any one of the numbered embodiments 45-48 wherein the processed cheese comprises kappa casein in an amount of at least 1% w/w relative to total protein, more preferably at least 3% w/w, even more preferably at least 5% w/w, and most preferably at least 10% w/w.

Numbered embodiment 50. The processed cheese according to any one of the numbered embodiments 45-49, wherein the processed cheese comprises kappa casein in an amount of 1-30% w/w relative to total protein, more preferably 3-20% w/w, even more preferably at least 5-15% w/w, and most preferably at least 10-13% w/w.

Numbered embodiment 51. The processed cheese according to any of the numbered embodiments 45-50, comprising essentially no para-kappa casein.

Numbered embodiment 52. The processed cheese according to any of the numbered embodiments 45-53, having a weight ratio between whey protein and casein of at most 0.5, more preferably at most 0.1, even more preferably at most 0.05, and most preferably at most 0.02.

Numbered embodiment 53. The processed cheese according to any of the preceding numbered embodiments, said processed cheese is obtainable by a method according to one or more of numbered embodiments 1-44.

The present invention has been described above with reference to specific embodiments. However, other embodiments than the above described are equally possible within the scope of the invention. The different features and steps of various embodiments and aspects of the invention may be combined in other ways than those described herein unless it is stated otherwise. Preferred embodiments may be freely combined unless they are mutually exclusive.

### EXAMPLES

### Methods of Analysis

### Analysis 1: Determination Total Protein

The content of total protein (true protein) is determined according to Example 9.2 of WO 2018/115520.

### Analysis 2: Determination of Viscosity

The determination of viscosity is carried out using a stress-controlled rheometer Physica MCR 301 (Anton Paar, Graz, Austria) equipped with a Peltier temperature controller. The temperature is maintained at 5 degrees C. or 20 degrees C. by connecting the rheometer to an external water bath (F12, Julabo GmbH, Seelbach, Germany). All measurements are conducted at 5 degrees C. or 20 degrees C. and the samples are equilibrated at the measurement temperature in the rheometer for 5 minutes prior to initiation of the shearing and the measurement. The geometry used is a concentric cylinder measuring system (diameter: 27 mm).

All samples are subjected to a steady flow test (shear rate ramp from 0 to 1000 s⁻¹ over 11 minutes). The viscosity at shear rate 145 s⁻¹ is recorded as the viscosity value unless is it stated otherwise.

The viscosity is presented in the unit centipoise (cP). The higher the measured cP values, the higher the viscosity.

### Analysis 3: Insoluble Protein Matter

The amount of insoluble protein matter of a liquid sample is quantified as the amount of protein that is removed from the sample by centrifugation at 3000 g for 5 minutes at 22 degrees C. using the following steps:
Approx. 20 g sample is adjusted to and equilibrated at 22 degrees C. and is added to centrifuge tubes and subsequently centrifugated at 3000 g for 5 minutes at 22 degrees C.
Total protein is measured prior to centrifugation of the sample total (P) and in the supernatant after centrifugation (P_{3000 g}) using Analysis 1.

If the sample is a powder, 10 g of the powder is suspended in 90 g demineralized water and allowed to hydrate at 22 degrees C. under gentle stirring for 1 hour. Approx. 20 g of hydrated sample (e.g. liquid sample of the suspended powder sample) is analysed as described above.

The percentage of insoluble protein matter is calculated as:

$$insoluble protein matter = ( \frac{{P}_{total} - {P}_{{3000}_{g}}}{{P}_{total}} ) * 100 \%$$

### Analysis 4: Determination of Ash Content

The ash content of a food product is determined according to NMKL 173:2005 “Ash, gravimetric determination in foods”.

### Analysis 5: Determination of the Total Solids of a Product

The total solids of a product may be determined according to NMKL 110 2^{nd} Edition, 2005 (Total solids (Water)—Gravimetric determination in milk and milk products). NMKL is an abbreviation for “Nordisk Metodikkomité for Næringsmidler”.

The water content of the solution can be calculated as 100% minus the relative amount of total solids (% w/w).

### Analysis 6: Determination of pH

All pH values are measured using a pH glass electrode and are normalised to 25 degrees C. The pH glass electrode (having temperature compensation) is rinsed carefully before and calibrated before use.

When the sample is in liquid form, then pH is measured directly in the liquid solution at 25 degrees C.

When the sample is a powder or in solid form, 10 gram of a powder is dissolved or dispersed in 90 ml of demineralised water at room temperature while stirring vigorously. The pH of the solution is then measured at 25 degrees C.

### Analysis 7: Determination of the Amounts of Calcium, Magnesium, Sodium, Potassium, Phosphorus (ICP-MS Method)

The total amounts of calcium, magnesium, sodium, potassium, and phosphorus are determined according to Example 9.5 of WO 2018/115520.

### Analysis 8: Determination of the Total Amount of Lactose

The total amount of lactose is determined according to ISO 5765-2:2002 (IDF 79-2: 2002) “Dried milk, dried ice-mixes and processed cheese—Determination of lactose content—Part 2: Enzymatic method utilizing the galactose moiety of the lactose”.

### Analysis 9: Determination of the Total Amount of Carbohydrate

The amount of carbohydrate is determined by use of Sigma Aldrich Total Carbohydrate Assay Kit (Cat MAK104-1KT) in which carbohydrates are hydrolysed and converted to furfural and hydroxyfurfurals which are converted to a chromagen that is monitored spectrophotometrically at 490 nm.

### Analysis 10: Determination of the Total Amount of Lipids

The amount of lipid is determined according to ISO 1211:2010 (Determination of Fat Content—Röse-Gottlieb Gravimetric Method).

### Analysis 11: Determination of the Casein Content Relative to Total Protein

The amount of casein is determined according to ISO 17997-1:2004, Milk—Determination of casein-nitrogen content—Part 1: Indirect method (Reference method).

### Analysis 12: Determination of the Whey Protein Content Relative to Total Protein

The amount of whey protein of a sample is calculated as the amount of total protein minus the amount of casein.

### Analysis 13: Determination of the Kappa Casein Content

The content of kappa casein of a sample is determined according to Holland et al; J. Dairy Sci.; 93; p. 893-900 and the sample is homogenised well after the initial mixing with the urea buffer.

### Example 1: Two Organic Slice-On-Slice Processed Cheeses Having a Low Sodium Content

This example demonstrates the feasibility of producing processed cheese arranged Slice-on-Slice using micellar casein isolate without natural cheese (cheese A) or alternatively with some natural cheese in addition to micellar casein isolate (cheese B). Both cheeses were fully organic. The two cheeses were produced using the recipes and process described below.

Recipe

| Ingredients | Cheese A | Cheese B |
|---|---|---|
| Micellar casein isolate powder, organic | 21.0% | 13.0% |
| Cheese, Gouda 50+, organic | 0% | 30.0% |
| Butter, unsalted, organic | 30.0% | 22.0% |
| Water | 43.9% | 30.3% |
| Tri-Sodium Citrate Dihydrate | 3.0% | 3.0% |
| NaCl | 1.2% | 0.8% |
| Lactic acid (80% liquid) | 0.9% | 0.9% |
| Total | 100% | 100% |

The amounts of ingredients are provided in % w/w. The micellar casein isolate was prepared from organic skim milk as outlined in Example 1 of PCT/EP2017/065315 and had a protein content of 87% w/w, approx. 95% casein relative to total protein, 1% w/w lactose, 1% w/w fat, and 8% ash. The micellar casein isolate contained approx. 0.1% w/w Na, 0.1% w/w Mg, 0.3% w/w K, and 2.5% w/w Ca.

### Process

Water, butter and cheese (only cheese B) were heated to 40° C. in Stephan Cooker UM/SK
The dry ingredients were added to the water and melted butter and mixed thoroughly for 5 minutes at 1500 r.p.m.
The pH of the mixture was adjusted to 5.6 by addition of lactic acid
The pH-adjusted mixture was heated to 95 degrees C. direct heating and held at that temperature for 5 minutes,
After the heat-treatment the mixture was hot-filled (85 degrees C.) into containers and cooled to 5 degrees C.,
The packaged processed cheese was stored at 5 degrees C. and subsequently cut into slices which were arranged slice-on-slice.

The nutritional values of the two cheese samples are shown below.

Nutritional values (% w/w)

| | Cheese A | Cheese B |
|---|---|---|
| Protein | 18.4% | 19.3% |
| Fat | 25.0% | 28.2% |
| Carbohydrate | 0.3% | 0.5% |
| Fat In Dry Matter | 50.6% | 52.6% |
| Total solids | 49.4% | 53.7% |
| Calcium | 0.5% | 0.6% |
| Sodium | 1.2% | 1.2% |
| Potassium | 0.1% | 0.1% |

The pH of processed cheeses A and B was approx. 5.7. Processed cheese A contained kappa casein in an amount of 11% relative to total protein and processed cheese B contained kappa casein in an amount of 7% relative to total protein.

The cheese slice samples were submitted to sensory testing by a test panel trained in tasting dairy products and were surprisingly found to have a creamy, mild and aromatic taste despite the reduced content of natural cheese. The two cheese samples were furthermore found to have a level of saltiness which was significantly higher than what was expected from a low sodium product.

Both cheeses had a surprisingly low degree of stickiness when sliced and were found to be highly suitable for processed cheese slices arranged slice-on-slice.

The MCI proved to have good emulsifying and texturizing properties for processed cheese production.

### Example 2: Organic Cheese Snack Having a Low Sodium Content

This example demonstrates the feasibility of producing a fully organic processed cheese-based snack product suitable for kids. The processed cheese-based snack product uses only 30% natural cheese and is supplemented with micellar casein isolate. The cheese snack was produced using the recipe described below and the process described in Example 1.

Recipe

| | Cheese C |
|---|---|
| Micellar casein isolate powder, organic | 11.0% |
| (see Example 1) | |
| Butter, unsalted, organic | 17.0% |
| Cheese, Cheddar 50+, organic | 30.0% |
| Water | 38.4% |
| Tri-sodium citrate dihydrate | 2.0% |
| NaCl | 1.0% |
| Lactic acid (80% liquid) | 0.6% |
| Total | 100% |

The amounts of ingredients are provided in % w/w.

The nutritional values of the obtained cheese sample are shown below.

Nutritional values

| | Cheese C |
|---|---|
| Protein | 17.5% |
| Fat | 24.1% |
| Carbohydrate | 0.5% |
| Fat In Dry Matter | 51.5% |
| Total solids | 46.8% |
| Calcium | 0.5% |
| Sodium | 1.0% |
| Potassium | 0.1% |

The pH of processed cheese C was approx. 5.7. Processed cheese C contained kappa casein in an amount of 6% relative to total protein.

The cheese snack sample was submitted to sensory testing by a test panel trained in tasting dairy products. Similar to the cheese slices of Example 1 the cheese snack was surprisingly found to have a creamy, mild and aromatic taste despite the reduced content of natural cheese.

The cheese snack was furthermore found to have a level of saltiness which was significantly higher than what was expected from a low sodium product.

Again, the MCI proved to have good emulsifying and texturizing properties for processed cheese production.

### Example 3: Organic Processed Cheese Spread Having a Low Sodium Content

This example demonstrates the feasibility of producing a fully organic processed cheese-based spread product. The processed cheese-based spread product uses only 25% natural cheese and is supplemented with micellar casein isolate. The cheese spread was produced using the recipe and process described below.

Recipe

| | |
|---|---|
| Micellar casein isolate powder, organic | 4.2% |
| (see Example 1) | |
| Cheese (Gouda 48+), organic | 25.0% |
| Butter, unsalted, organic | 15.3% |
| Water | 47.4% |
| Skimmed milk powder, organic | 6.7% |
| NaCl | 0.5% |
| Tri sodium citrate dihydrate | 0.9% |
| Total | 100% |

Process
Cheese, butter and water were added into a Tetrapak high shear batch mixer and heated to 47 degrees C. using indirect heating (50% speed)
The dry ingredients were added to the mixture mixed for 4 minutes, at high shear (50-65% speed), under vacuum (500-600 mbar)
The pH of the mixture was adjusted to pH 5.8 using lactic acid (80% purity)
The pH-adjusted mixture was then heated to 60 degrees C. using indirect heating, with low shear (30% speed) and subsequently heated to 90 degrees C. using direct steam and was held at that temperature for 5 minutes (30% speed)
Subsequently the heat-treated mixture was subjected to shearing for 10-15 minutes (15% speed) at 85 degrees C.
Finally the mixture was hot-filled at 85 degrees C. into cups, which were sealed and stored cold at approx. 5 degrees C.

The nutritional values of the obtained cheese sample are shown below.

Nutritional values

| | Cheese D |
|---|---|
| Protein | 11.9% |
| Fat | 20.0% |
| Carbohydrate | 3.6% |
| Lactose | 3.6% |
| Sodium | 0.65% |
| Potassium | 0.1% |
| Fat In Dry Matter | 50.3% |
| Total solids | 39.7% |

The pH of processed cheese D was approx. 5.7. Processed cheese D contained kappa casein in an amount of 4% relative to total protein.

The cheese spread sample was submitted to sensory testing by a test panel trained in tasting dairy products. Similar to the cheese slices of Example 1 and the cheese snack of Example 2, the cheese spread was surprisingly found to have a creamy, mild and aromatic taste despite the reduced content of natural cheese. The cheese spread was also found to have a clean and milky taste and a level of saltiness which was significantly higher than what was expected from a low sodium product.

The inventors were furthermore more surprised to find that even though the cheese spread only contained 25% natural cheese this did not appear to compromise the firmness, texture and spreadability of the product.

Again, the MCI proved to have good emulsifying and texturizing properties for processed cheese production.

### Example 4: Sweet Processed Cheese Snacks Having a Low Sodium Content

This example demonstrates the feasibility of producing sweet processed cheese snacks containing e.g. fruit flavour or caramel flavour. The processed cheese-based snack products used only 18% cream cheese and were supplemented with 19% micellar casein isolate. The cheese snacks were produced using the recipes and process described below:

Recipe

| | |
|---|---|
| Micellar casein isolate powder, organic | 19.0% |
| Tri sodium citrate dihydrate | 2.3% |
| Citric acid | 0.5% |
| Butter, unsalted, organic | 16.0% |
| Cream cheese (30% fat) | 18.0% |
| Water | 33.8% |
| Sucrose | 10.0% |
| Banana flavour | 0.2% |
| Organic, yellow fruit colour | 0.2% |
| Total | 100% |

The micellar casein isolate powder was similar to the one used in Example 1 but contained approx. 96% w/w total solids, approx. 80% w/w protein of total solids, and approx. 95% w/w casein relative to total protein.

A caramel-flavoured processed cheese snack was furthermore prepared using the above recipe but replacing the flavour and colour with cream caramel flavour and brown colour.

A strawberry flavoured processed cheese snack was furthermore prepared using the above recipe but replacing the flavour and colour with strawberry flavour and red colour.

### Process

Cream cheese, butter and water were added into a Sharp Batch Cooker and heated to 45 degrees C. using indirect heating during mixing (1000 r.p.m. for 5 minutes)
The dry ingredients were added to the mixture and mixed for 4 minutes
The pH of the mixture was adjusted to pH 5.5 using the citric acid
The pH-adjusted mixture was then heated to 60 degrees C. using indirect heating, with low shear (750 r.p.m.) and subsequently heated to 92 degrees C. and was held at that temperature for 5 minutes (750 r.p.m.)
Finally the mixture was hot-filled at 80 degrees C. into cups, which were sealed and stored cold at approx. 5 degrees C.

The nutritional values of the obtained cheese snacks are shown below.

Nutritional values

| | Cheese snacks |
|---|---|
| Protein | 15.9% |
| Fat | 18.1% |
| Carbohydrate | 12.1% |
| Lactose | 2.1% |
| Sodium | 0.55% |
| Calcium | 0.47% |
| Total solids | 50.3% |

The pH of processed cheese snacks were approx. 5.5. The processed cheese snacks contained kappa casein in an amount of approx. 8% w/w relative to total protein.

The sweet processed cheese snacks were submitted to sensory testing by a test panel trained in tasting dairy products. Similar to the cheese slices of Example 1 and the cheese snack of Example 2, the sweet processed cheese snacks were found to have a creamy, mild and aromatic taste despite the reduced content of natural cheese. The cheese snacks were also found to have a clean and milky taste and a level of saltiness which was significantly higher than what was expected from a low sodium product. The inventors also observed that processed cheeses based on a significant amount of micellar casein had less umami taste than traditional processed cheeses and believes this to contribute to the improved taste of the present products.

The inventors were furthermore more surprised to find that even though the cheese snacks only contained 18% cream cheese it did not compromise the firmness and texture of the processed cheese product.

Again, the MCI proved to have good emulsifying and texturizing properties for processed cheese production.

1. A method of preparing a processed cheese comprising sodium in an amount of at most 1.5% w/w, which method comprises the steps of:
a) providing a dairy mixture comprising water, melted fat, a micellar casein isolate (MCI), sodium chloride, and a melting salt, the dairy mixture having a pH in the range of 5.0-6.5, wherein the MCI contributes with at least 35% w/w of the protein of the dairy mixture, and wherein the dairy mixture has a content of sodium of at most 1.5% w/w,
b) subjecting the dairy mixture to heat treatment at a temperature of 80-150 degrees C. for a period of 2 seconds-10 minutes,
c) filling the heated dairy mixture in a suitable container, preferably at a temperature of 35-90 degrees C., thereby obtaining a packaged dairy mixture, and
d) optionally, storing the packaged dairy mixture for at least 1 day, preferably at a temperature of 2-40 degrees C.

2. The method according to claim 1 furthermore comprising a step e) of cutting the dairy mixture obtained from step c) or step d) thereby obtaining a cut dairy mixture.

3. The method according to claim 1 or 2 wherein the processed cheese is:
the packaged dairy mixture obtained from step c),
the packaged dairy mixture obtained from step d), or
the cut dairy mixture of step e).

4. The method according to any of the preceding claims, wherein the MCI contributes with at least 50% w/w of the protein of the dairy mixture, more preferably at least 70% w/w, even more preferably at least 90% w/w, and most preferably at least 95% w/w.

5. The method according to any one of the preceding claims, wherein the MCI has a weight ratio between sodium and protein of at most 0.0057, more preferably at most 0.0023, even more preferably at most 0.0011, and most preferably at most 0.00057

6. The method according to any one of the preceding claims, wherein the dairy mixture has a protein content of 7-35% w/w, more preferably 9-30% w/w, and most preferably 11-25% w/w.

7. The method according to any one of the preceding claims, wherein the dairy mixture comprises native whey protein in an amount of at most 10% w/w relative to total protein, more preferably at most 8% w/w, even more preferably at most 5% w/w, and most preferably at most 2% w/w.

8. The method according to any one of the preceding claims, wherein the dairy mixture comprises casein in an amount of at least 90% w/w relative to total protein, more preferably at least 92% w/w, even more preferably at least 95% w/w, and most preferably at least 98% w/w.

9. The method according to any one of the preceding claims, wherein the dairy mixture comprises kappa casein in an amount of at least 3% w/w relative to total protein, even more preferably at least 5% w/w, and most preferably at least 10% w/w.

10. The method according to any of the preceding claims, wherein cheese contributes with at most 65% w/w of the protein of the dairy mixture.

11. The method according to any one of the preceding claims, wherein pH of the dairy mixture is 5.4-6.0, most preferably 5.5-5.8.

12. The method according to any one of the preceding claims, wherein the dairy mixture more preferably has a content of sodium of at most 1.3% w/w, even more preferably at most 1.2% w/w, and most preferably at most 0.6.

13. The method according to any one of the preceding claims, wherein the dairy mixture has a content of potassium in the range of 0.01-1% w/w, more preferably 0.02-0.8% w/w, even more preferably 0.03-0.6% w/w, and most preferably 0.05-0.3% w/w.

14. A processed cheese comprising sodium in an amount of at most 1.5% w/w and having:
a fat content of 5-40% w/w, more preferably 8-35% w/w, and most preferably 10-30% w/w,
a protein content of 7-35% w/w, more preferably 10-30% w/w, and most preferably 12-25% w/w,
a carbohydrate content of at most 15% w/w, more preferably at most 10% w/w, and most preferably at most 5% w/w,
a solids content of 25-65% w/w, more preferably 30-60% w/w, and most preferably 35-55% w/w,
a content of kappa casein in an amount of 3-30% w/w relative to total protein, and
a pH of 5.0-6.5.

15. The processed cheese according to claim 14, wherein the processed cheese more preferably comprises kappa casein in an amount of 3-20% w/w, even more preferably at least 5-15% w/w, and most preferably at least 10-13% w/w.

16. The processed cheese according to claim 14 or 15 obtainable according to one or more of claims 1-13.

17. Use of a micellar casein isolate for one or more of:
For producing a processed cheese and using the MCI as an ingredient, preferably contributing with at least 35% w/w of the protein of the processed cheese, more preferably at least 50% w/w, even more preferably at least 70% w/w and most preferably at least 95% w/w of the protein of the processed cheese,
Reducing the amount of melting salt required in a processed cheese by using the MCI as an ingredient in the processed cheese,
Reducing the content of sodium of a processed cheese by using the MCI as an ingredient in the processed cheese,
Producing a processed cheese comprising sodium in an amount of at most 1.5% w/w, and more preferably at most 1.3% w/w, even more preferably at most 1.0 and most preferably at most 0.7% w/w, and
Increasing the salty taste per mg sodium of a processed cheese.
